(19) United States
(12) Patent Application Publication
(10) Pub. No.: US 2014/0252002 A1
(43) Pub. Date: Sep. 11, 2014

(54) WASTE REMOVAL SYSTEM

(71) Applicants: Michael Robert Donoghue, Memphis, TN (US); Joseph Michael Ferrante, Bartlett, TN (US)

(72) Inventors: Michael Robert Donoghue, Memphis, TN (US); Joseph Michael Ferrante, Bartlett, TN (US)

(21) Appl. No.: 14/198,113

(22) Filed: Mar. 5, 2014

Related U.S. Application Data
(60) Provisional application No. 61/775,507, filed on Mar. 9, 2013.

(51) Int. Cl. B65F 1/14

(52) U.S. Cl. CPC B65F 1/1415
USPC 220/495.09; 220/495.01; 220/495.06

(57) ABSTRACT

The invention relates to a yard waste collection device that provides an efficient method to quickly collect, contain and bag yard debris, by allowing the operator to sweep the yard debris directly onto a series of stacked flat sheets or stacked, tarp-like bags attached to a mobile frame. The device (1) includes the combination of flat sheets or flat, tarp-like bags (15) with draw string or tape (13) and a frame (1) that contains, through an attachment mechanism, either a single or multiple flat sheets or tarp-like bags (15). The flat sheet or tarp-like bag can be easily removed from the frame once debris is raked into the sheet or bag by releasing the four tabs from the post on the frame and by pulling the four corners together. The draw string or tape (13) of the flat sheet or tarp-like bag is drawn up and the full sheet or bag is removed and transported as needed. The device is instantly ready to continue the collection because the next tarp-like bag (15) underneath the first bag is in place.

### CROSS-REFERENCE TO RELATED APPLICATIONS

This application claims the benefit of provisional patent application Ser. No. 61/775,507 filed 2013 Mar. 9 by the present inventor.

### BACKGROUND OF THE INVENTION

Homeowners and landscape professionals utilize many methods in an attempt to quickly and efficiently collect yard waste. Rakes and leaf blowers are common household tools used to move yard debris into large piles so that they may be collected. Once collected, the homeowner or landscape professional employs various methods to manually place the yard waste into a yard bag or can liner. However, current yard waste collection methods remain a laborious chore for the homeowner or landscaper, and a more efficient system could greatly speed up the process of collecting and disposing yard debris.

Various types of products have been developed to attempt to more efficiently place yard debris into standard can liners or yard bags. They include such products as draw-string bags, tarps, rigid sheets, and upright bag holders. These solutions however are merely improvement in methods to transport yard debris or to facilitate placement of yard debris into a single yard bag or can liner. Furthermore, these products require the operator to manually fill and enclose each individual bag, often resulting in the operator having to repeatedly bend over to pick up yard debris and place it in the bag. Next, the operator is required to prepare another bag for manual loading. These current yard waste collection methods remain a laborious and time consuming chore for the homeowner. Thus, there remains a need for a system that can more quickly and efficiently place the yard debris into a container, enclose the yard debris for transportation, and allow for the next deposit of debris to be immediately collected into the container.

Many devices have been developed to collect, contain or remove yard debris. U.S. Pat. No. 7,552,956 describes a tarp or sheet that will allow for large amounts of debris to be collected and transported to another location for storage and pickup. This type of device allows for collection but is limited to areas where debris can be picked up by large machines for local waste removal, as it does not facilitate containment of the yard debris in bags. U.S. Pat. No. 6,758,596 describes a foldable tarp that is used as a carrying device, but does not serve as a yard debris bag ready for community disposal. U.S. Pat. No. 5,722,220 describes a flat bag with a closure mechanism, but the device does not attach to a frame to allow multiple bags to be stacked for easy leaf disposal and rapid redeployment of subsequent bags. U.S. Pat. No. 5,593,117 describes an apparatus that holds open a traditional trash bag for raking yard debris, but does not describe a flat tarp-like bag. U.S. Pat. No. 4,561,480 merely provides a means to transport debris but does not allow for permanent storage and removal means for the debris.

Other devices previously described include U.S. Pat. No. 5,580,635, which is a collection tarp designed as a single collection apparatus to transport leaves, but does not form an individual bag or have a means to attach to a frame for stacking multiple tarp-like bags. U.S. Pat. No. 5,364,188 describes a flat sheet where the corners are gathered and adhered to contain the yard debris, but does not have a mechanism to attach to a frame for stacking multiple tarp-like bags to a frame. U.S. Pat. No. 4,955,068 describes a single flat sheet with a drawstring and a ground insertion spike, but does not describe an attachment mechanism to stack multiple tarp-like bags to a mobile frame. U.S. Pat. No. 4,938,607 also describes a single sack-forming sheet but the apparatus does not provide an attachment mechanism to stack multiple tarp-like bags to a mobile frame.

A final series of debris removal devices are designed to maintain existing trash bags in the open position to allow for easier collection of the debris. These types of devices are meant to work with standard trash bags or can liners. U.S. Pat. No. 6,315,143 describes a disposable standing trash bag with a flexible container which requires the operator to pick up and place the yard debris into a single upright bag. U.S. Pat. No. 7,237,753 describes a sleeve attached to a single standard trash bag or can liner to maintain the bag in the open position. U.S. Pat. No. 6,994,302 is also designed to maintain a single trash bag in the open position. All of these products require the operator to repeatedly bend over and return to the upright position in order to place yard debris in a standard trash bag or can liner.

### BACKGROUND OF THE INVENTION

Although prior disclosures demonstrate some improvement in the collection of yard debris, they fall short in significantly reducing the time and effort required to collect, contain, and bag yard debris. The invention described in this patent offer several distinct advantages over the prior art listed.

### SUMMARY

The invention comprises a series of sealable or closable flat sheets or tarp-like bags that are attached to a foldable frame that secure the sheets or bags in place. The sheets or tarp like bags are flat, and can lay on top of one another in a stacked fashion. The stacked sheets or tarp-like bags may be packaged so that all of the sheets or bags in the package can be attached to the frame at one time. The sheets or tarp-like bags have an attachment mechanism (or means) that allows the stacked sheets or bags to be easily fixed to the frame. The frame consists of a mating attachment mechanism (or means) that will house the stack of sheets or tarp-like bags in a secure position. The operator then simply sweeps the yard debris onto the top sheet or tarp-like bag, loosens the sheet or tarp-like bag from the frame, and uses the designed enclosure mechanism to fully contain the yard debris. Because the next sheet or bag is also attached to the frame, the operator is immediately prepared to sweep the next pile of yard debris onto the next sheet or tarp-like bag. The low profile structure of the frame and the secured flat sheets or tarp-like bags allow easy sweeping of yard debris onto the topmost sheet or bag without disassociating the sheet or tarp-like bag from the frame. Furthermore, the frame is lightweight and easy to move, with the sheets or bags remaining secure to the frame, to the next pile of yard debris. The mobility of the frame allows for efficient collection of yard debris. The stacking of multiple sheets or tarp-like bags eliminates the need to prepare a new sheet or bag after complete filling of the previous one, as is necessary with typical trash bags, can liners and current yard debris containment systems. The frame is foldable for easy and compact storage, as well as quick assembly and disassembly. In addition, the unused sheets or tarp-like bags can remain connected to the frame for subsequent uses. The interaction of the specifically designed sheets or tarp-like bags with the mobile frame make this system novel compared to other prior disclosures. This unique approach greatly reduces the time and effort required to collect, contain, and bag waste compared to previous attempts.

Another embodiment of the present invention relates generally to a yard waste containment system that is a polygonal or circular shaped, rigid, foldable frame, and an enclosable flat tarp-like sheet(s) bag or container(s) that is connected to the rigid frame. The above mentioned apparatus rests flat on the ground. The rigid foldable frame is designed to contain one or more tarp-like sheets. The flat tarp-like bags are held in place by its connection(s) to the external frame. The yard waste is deposited onto the tarp-like flat container with a rake or blower. When the yard waste is fully deposited onto the tarp-like container, the container is separated from the frame, and the edges of the container are brought together and enclosed by the enclosure mechanism, such as a draw string. The enclosed tarp-like container forms a bag-like system so that the contained yard waste can be easily moved for final waste disposal. The unused tarp-like containers that were placed under the previously used tarp-like bag remain connected to the frame and are immediately ready to be deployed when the next deposit of yard waste is placed into the containment system. These novel features greatly shorten the total time and effort required to contain yard debris for waste collection.

### FIGURES

FIG. 1 is a prospective view of the preferred embodiment frame assembled and unfolded.

FIG. 1A is a prospective view of the preferred embodiment frame assembled and unfolded.

FIG. 1B is a prospective view of an alternate embodiment of a three leg assembled and unfolded frame in a shape of a U

FIG. 2 is a corner view of the preferred embodiment frame, showing the hinge component of the assembly showing post and hinge. There are two in the frame.

FIG. 2A is a corner view of the preferred embodiment frame, showing the 45 degree underside hinge component of the assembly with post and hinge. There is one in the frame assembly.

FIG. 3 is a corner view of the alternate embodiment frame, with a triangular shape showing the hinge component of the assembly with post and lip. There are two in the frame assembly.

FIG. 3A is a corner view of an alternate embodiment frame, showing a cartridge assembly for the semi flat sheets or bags. The cartridge component holds the draw tape or string of the bag.

FIG. 4 is a corner view of the alternate embodiment frame, showing the 45 degree underside hinge component of the assembly with post, post plate and hinge. There is one in the frame assembly.

FIG. 5 is an exploded view of the snap hinge components of the frame. The view shows the male and female end of the snap hinge and preferred release mechanism.

FIG. 5A is a cornet view of the snap hinge components of the frame. The view shows the snap hinge of the preferred release mechanism assembled.

FIG. 6 is an exploded view of an alternate embodiment of the snap hinge components showing the female receiving mechanism for assembly.

FIG. 6A is a corner view of an alternate embodiment of the snap hinge components showing the male receiving mechanism for assembly and release mechanism.

FIG. 7 is a prospective view of the preferred embodiment assembly of the frame showing the folding ability of the frame.

FIG. 8 is a corner view of a component of the preferred embodiment showing the folding ability of the assembly.

FIG. 9 is a prospective view of the preferred embodiment assembly of the frame showing the a completely folded frame

FIG. 10 is an exploded view of the preferred embodiment frame assembly showing a completely open frame with multiple flat sheet bags.

FIG. 11 is a prospective view of the preferred embodiment assembly of the frame showing a completely open frame with multiple bags in place.

FIG. 12 is a prospective view of the preferred embodiment assembly, showing a completely open frame with multiple bags in place. The drawing shows the operator folding one bag leaving the next ready for collection.

REFERENCE NUMBERS

| | |
|---|---|
| 1 | Frame |
| 2 | Post |
| 3 | Hinge |
| 4 | Plate |
| 5 | Triangular Frame Underside hinge |
| 6 | Lock tab |
| 7 | Snap locking tab |
| 8 | Receiving slot |
| 9 | Receiving hole |
| 10 | Release tab |
| 11 | Locking post |
| 12 | Flat end segments |
| 13 | Draw string |
| 14 | Flat tarp like Bag |
| 15 | Multiple flat bags |
| 16 | Multiple bag attachment |
| 17 | Cartridge |
| 18 | Cartridge slot |
| 20 | Drawstring slot |
| 21 | Triangular cross section frame |
| 22 | Round Post lip |
| 23 | Triangular frame hinge |
| 24 | U shaped Frame |
| 25 | Round hinge body |
| 26 | Circular body arm |
| 27 | Round frame Underside hinge |
| 28 | Snap hinge male post |
| 29 | Snap hinge locking spring pin |
| 30 | Snap hinge female receiver |
| 31 | Round hinge component |
| 32 | Folded frame assembly |
| 33 | Folded flat bag |
| 34 | Multiple draw string/tape |

### DETAILED DESCRIPTION OF THE DESIGN

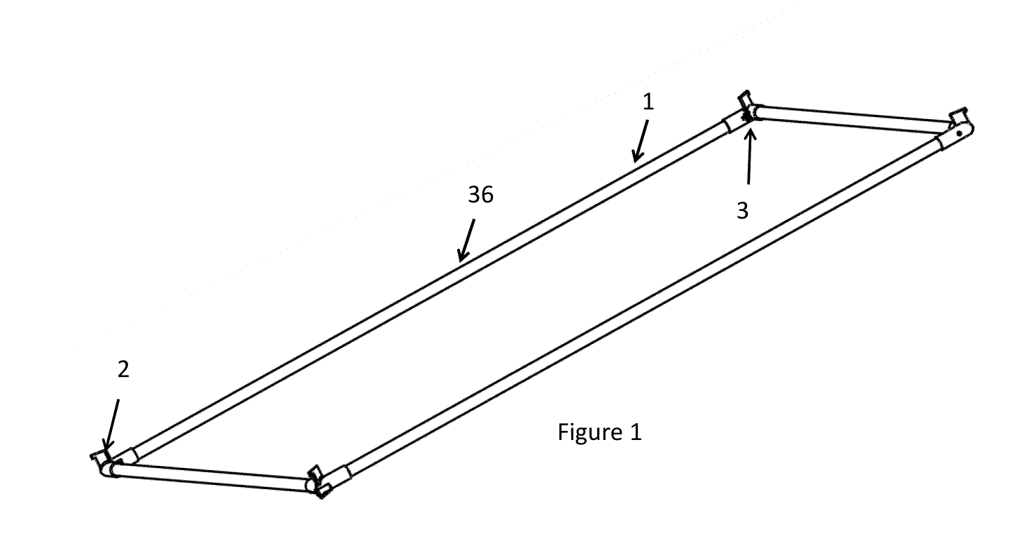

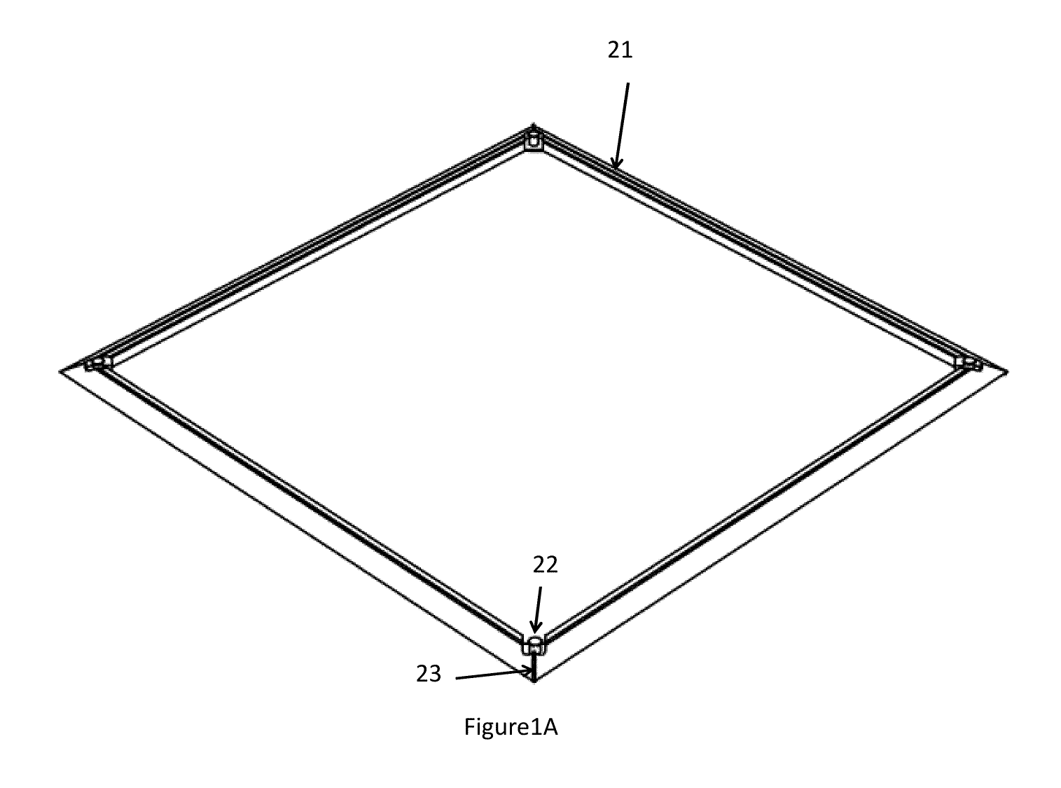

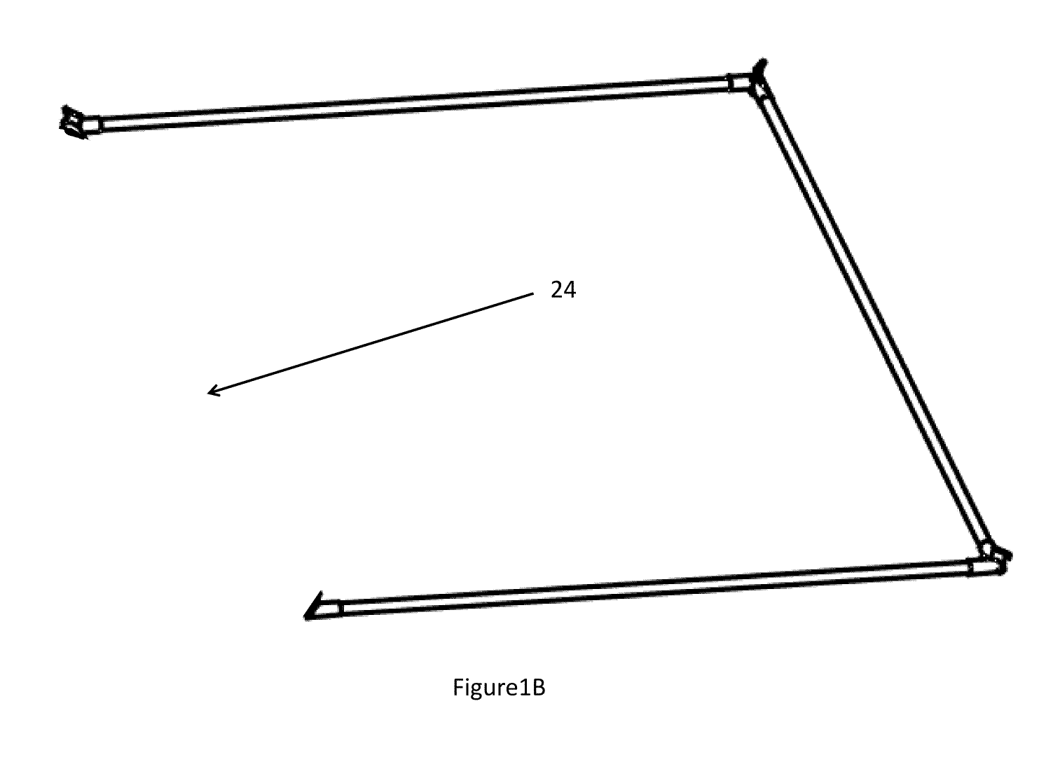

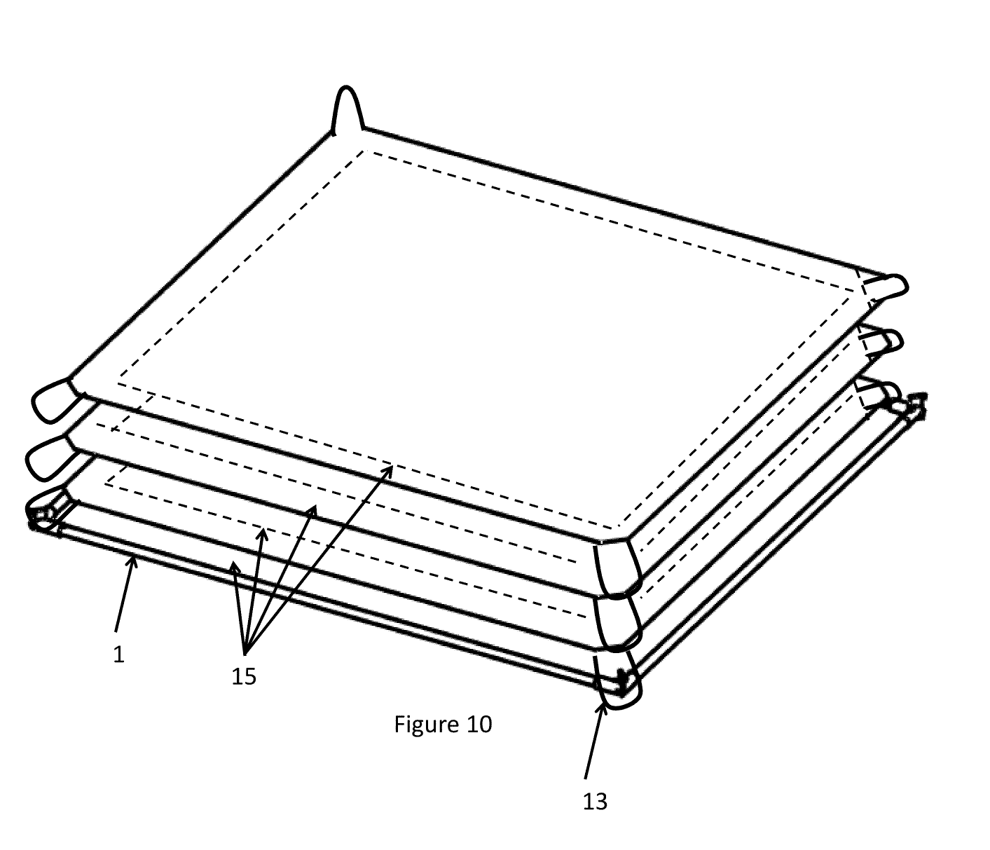

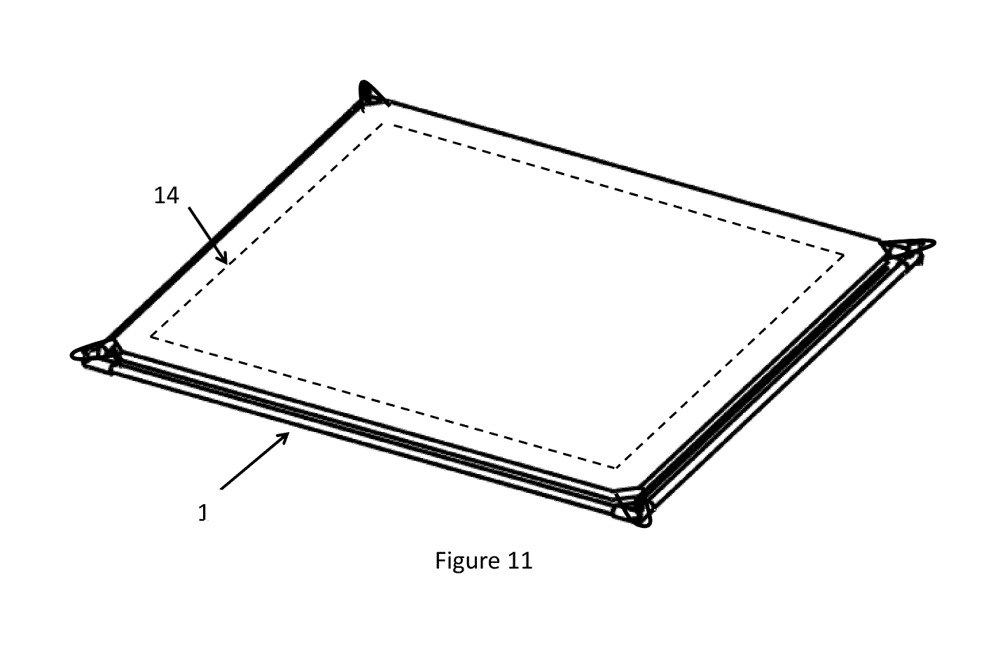

An exemplary embodiment of the invention is illustrated in FIGS. 10-12 The device consists of a frame (1) and at least one flat sheet or tarp-like bag (15) or multiple sheets or tarp like bags that can be used to pick up waste or yard debris for disposal. The device can have a foldable or fixed frame that can support the sheet(s) or tarp like bag(s) (15) in an open position, so that the sheets or bags (15) can lie flat on the ground for collection of debris and leaves. The design allows for an instantly ready sheet or tarp like flat bag (15) approach that allows the consumer to collect the debris by sweeping, placing or raking the debris into a contained area inside the frame. Once the debris is gathered, the multiple draw strings or tape (34) on the sheet or bag (15) are pulled forming a closed bag (33). This automatically presents the next sheet or bag (15) for immediate collection. The frame (1) as shown in FIG. 1 consists of multiple segments or components (36) but the frame can be made of as few as one segment or component (36) if the frame is not foldable.

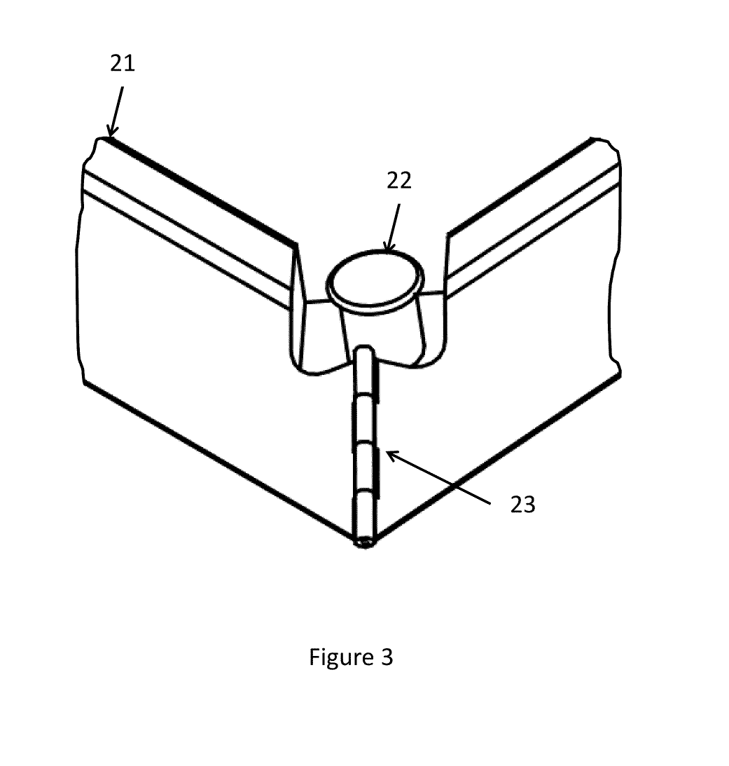

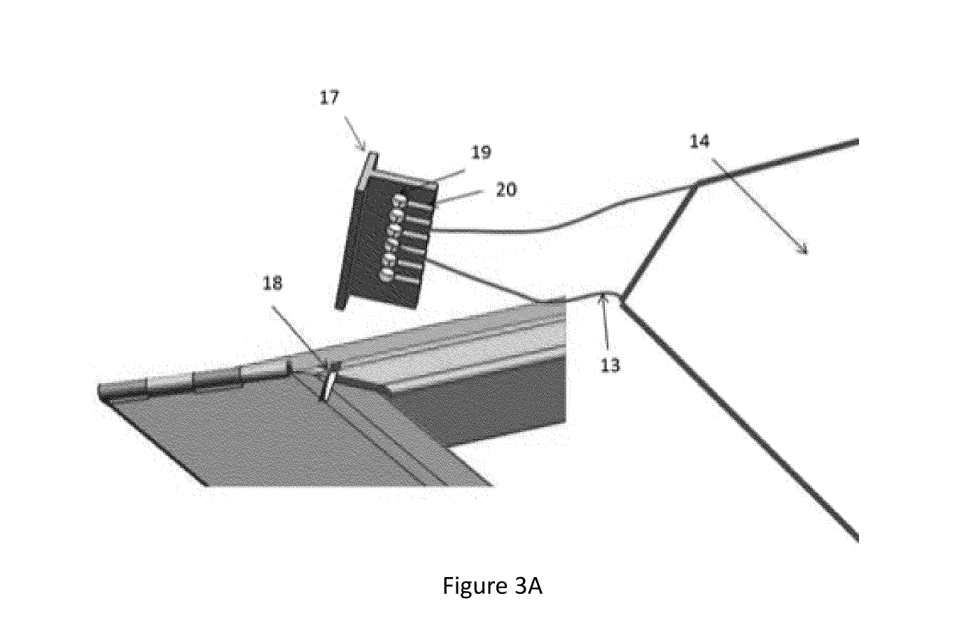

The frame (1) as shown in FIG. 1 is constructed of segments (36) which are of a circular cross-section or rounded (also referred as rounded peripheral edge portions). Another exemplary frame (1) may have an angled peripheral edge portions and are constructed with segments (36) having triangular cross section (21) as shown in FIG. 1A and FIG. 3 to allow for easy flow of debris over the frame onto the sheet or tarp like bag. The frame (1) shown in FIG. 1 can be constructed of one segment or piece (36) or of multi segments or pieces (36) for a foldable frame assembly (32) as shown in FIG. 9. The frame (1) has an overall square shape as shown in FIG. 1A. However, many polygonal shaped frames can be developed. A frame that is circular in shape can also be developed. The frame (1) in FIG. 1 is constructed of four segments. However, an open U shaped frame (24) as shown in FIG. 1B that has three segments (36), can also be made to be rigid or semi rigid. The frame (1) can be made of many different types of material including metal, plastic, PETG, abs plastic, or various polymers through injection molding, compression molding layup or machining, or any combinations thereof, as known to anyone skilled in the art.

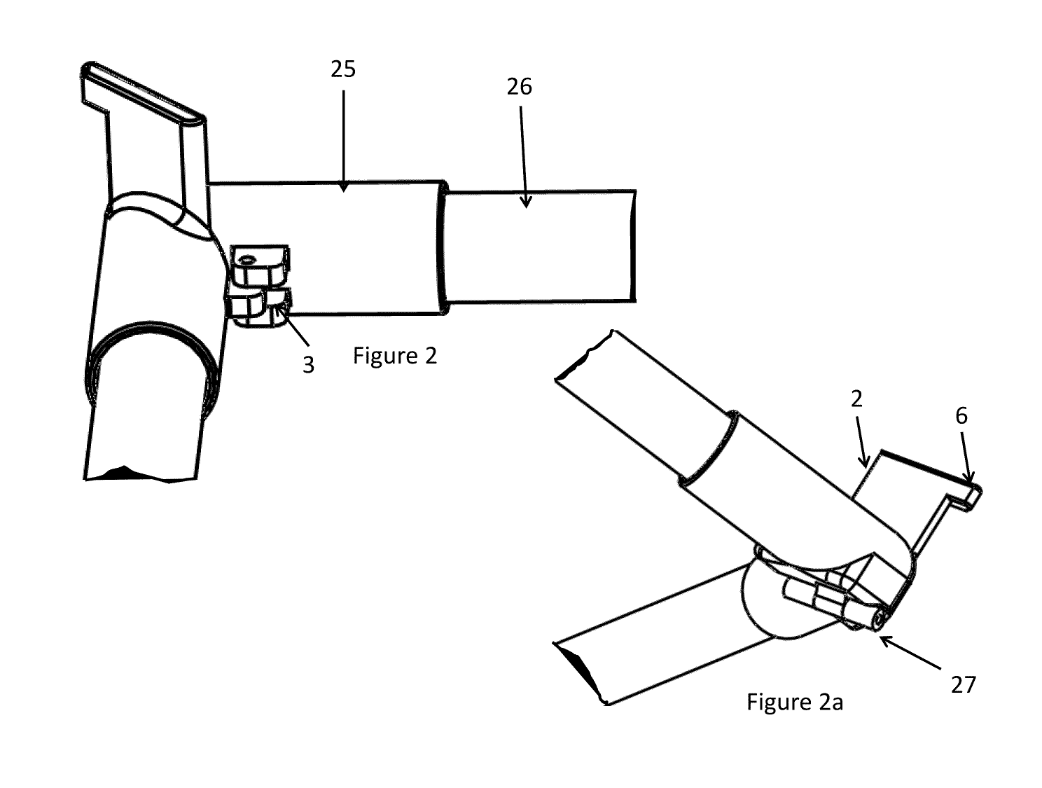

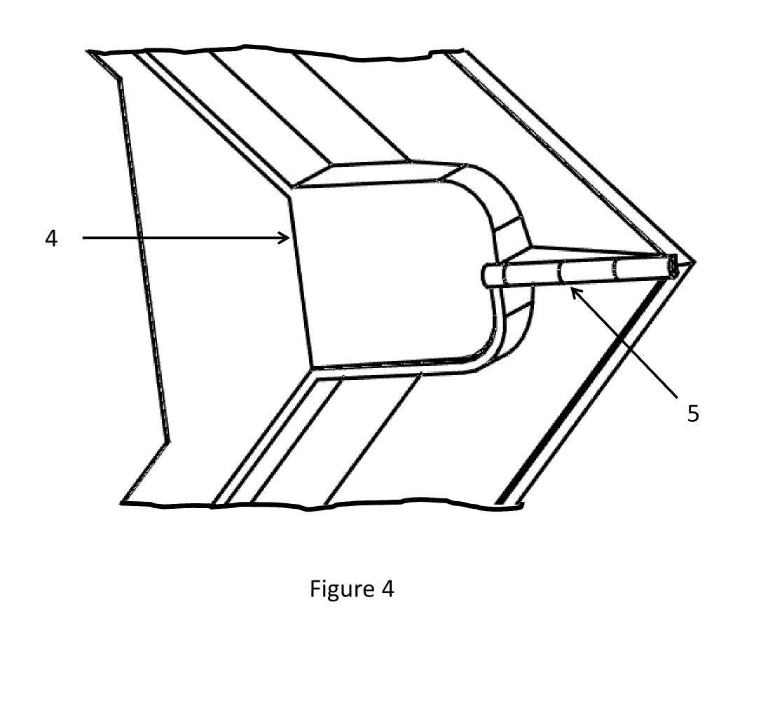

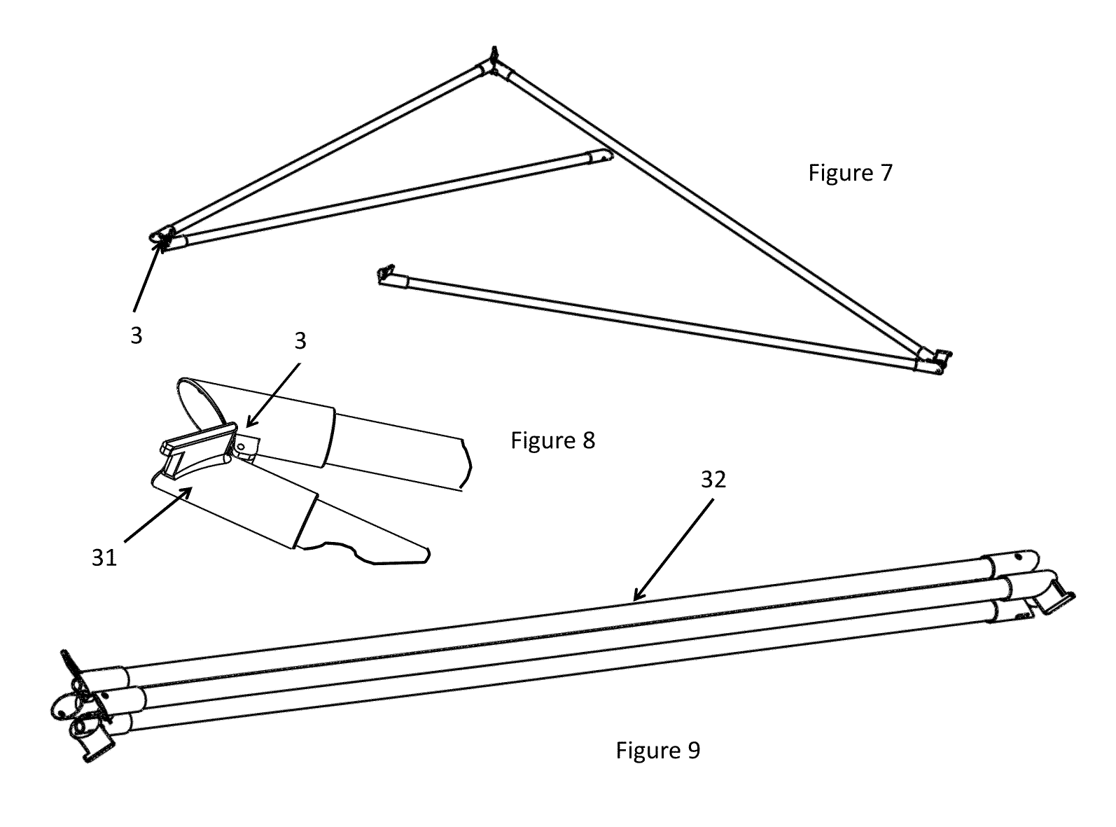

In order to connect the segments (36) together to form the frame (1), an exemplary frame (1) is constructed of multiple circular cross section segments having rounded peripheral edges (36) attached to end components (25) as shown in FIG. 2. The end components (25) can be separate or integral to the segments (36) as shown in FIG. 1A which shows an exemplary frame (1) having triangular cross section segments with angled peripheral edges (21) and the end components are integral to the segments (36). The exemplary end components (25) as shown in FIGS. 2, 2A and 4 have connection means such as inside hinges (3) and underside hinges (27), (5) that allow the segments (36) to connect, rotate and fold upon each other for storage. Any connection means and arrangement of the same which provides similar functions known to one skilled in the art can be used. Hinges can be separate or integral components to the frame. The exemplary embodiment shown in FIG. 1A includes a frame constructed of multiple segments (21) that are connected by hinges which are built into the segments. The hinges can either be molded into the frame segments (36) or can be attached by a mechanical attachment. They can be a living hinge type mechanism. The function of the hinge mechanism is to allow for the frame to fold on to itself as shown in FIG. 7 for tight space easy storage.

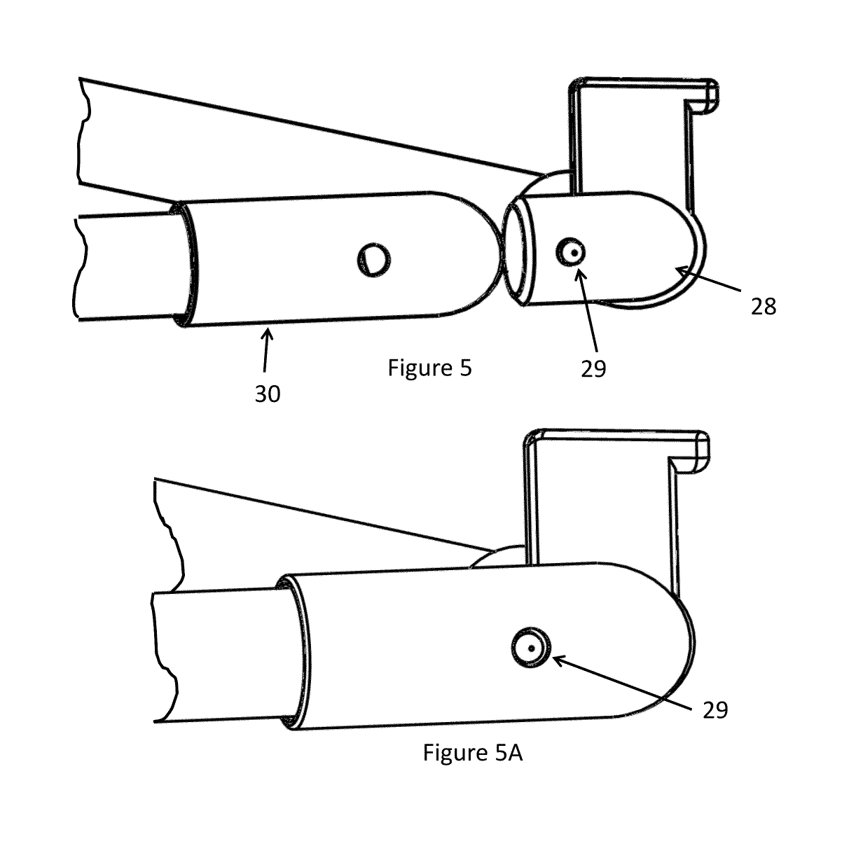

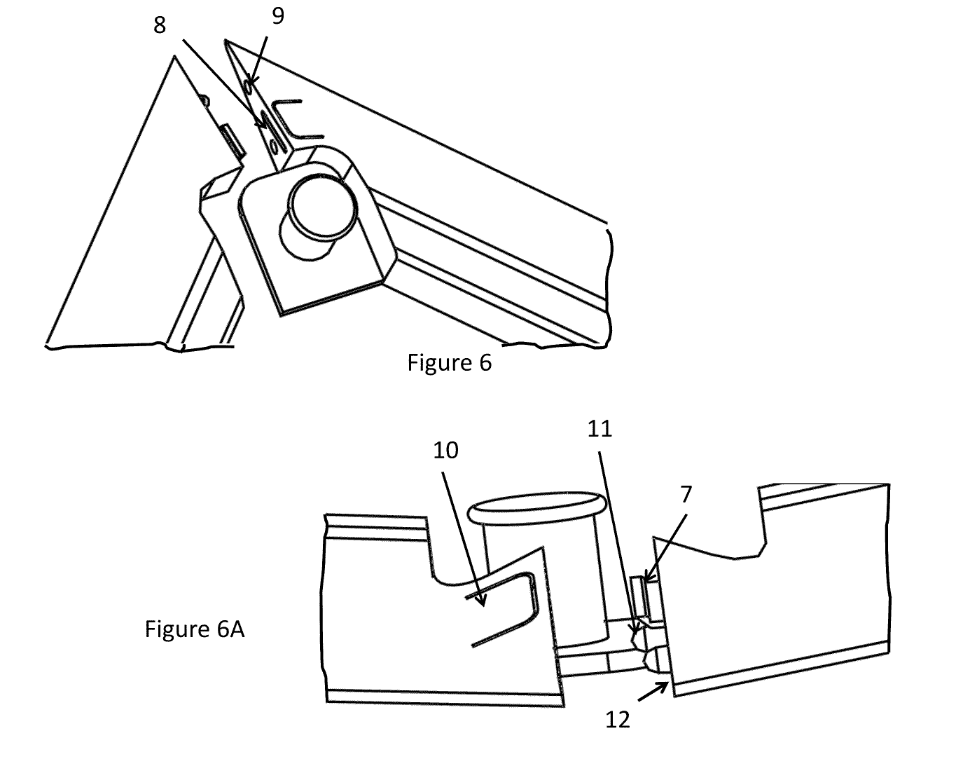

FIG. 8 shows the round hinge component 31 in a folding configuration. Alternate embodiments of hinges which can be used with the invented device include snap hinge female receiver (30) which mates to a snap hinge male post (28) as shown in FIG. 5. This is done by pushing on the snap hinge locking spring pin (29) which releases the snap hinge segments. FIG. 5A shows the segments in the locked position. The alternate embodiments shown in FIGS. 6 and 6A include a receiver hole 9 and receiver slot 9 that accept snap locking tab 7 and locking post 11 to assemble the flat end segments 12 together. The release tab 10 is pushed on to disconnect snap locking tab 7.

To attach the flat sheets or tarp-like bags to the frame, an attachment means such as a post (2) is constructed on or coupled to the segments (36) as shown in FIG. 2A. The post (2) is an attachment mechanism on the frame (1) for allowing another attachment or enclosure mechanism on the flat sheets or the tarp-like bags such as the drawstring/tape (13) shown in FIG. 10 to be attached to the frame by placing it over the lip (6) of the post (2). The exemplary frame has three posts (2) to keep the bag(s) open on the frame and to attach to the frame. This is seen in FIG. (10) and FIG. (11). Other exemplary attachment means on the frame (1) are shown in FIGS. 3, 3-A and 4. A cartridge system as an exemplary attachment means shown in FIG. 3-A allows for a paper T cartridge (17) to be place into a T slot (18) in the four corners of the frame (1) after assemble or unfolding. The paper T-cartridge (17) provides a means for attachment of multiple flat sheets or bags (14). The slots (20) and holes (19) of the paper T cartridge (17) allow for easy removal by the operator.

The flat sheets or tarp-like bags (15) can be made of synthetic or cellulosic materials or combinations thereof, including plastic film, paper sheet, cloth, foil, netting, mesh, wood, polymer or any mixtures thereof. The sheets or bags can be woven, knitted, non-woven, or netting. The sheets or bags can be a single sheet or laminated sheets.

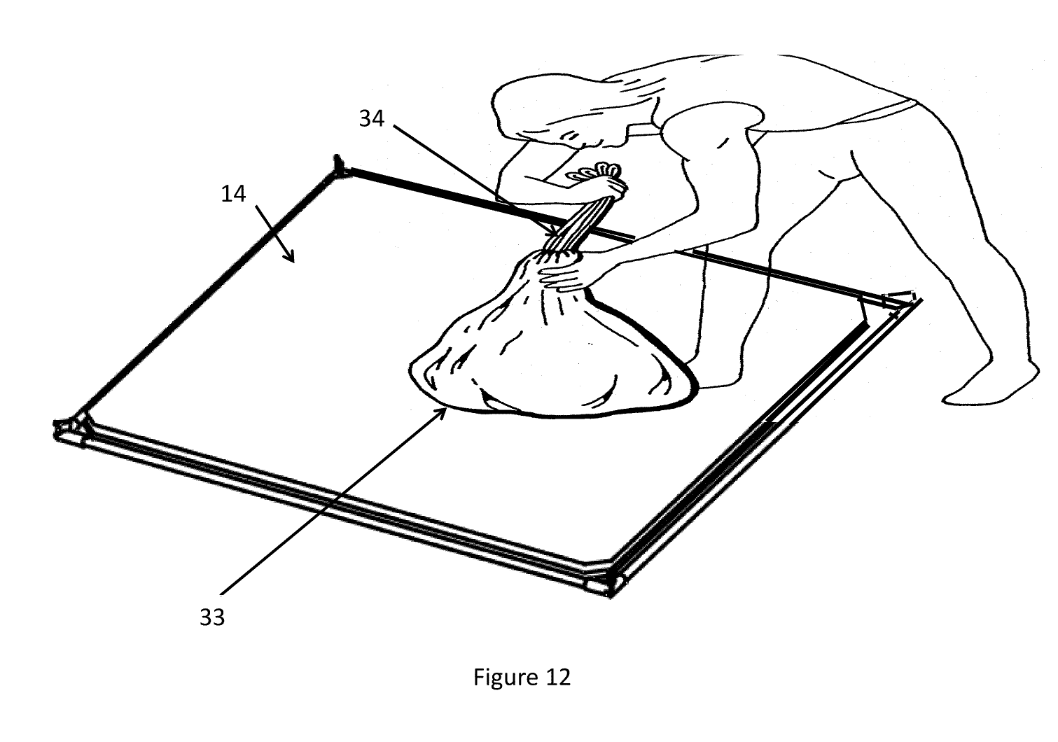

The frame as an assembly allows the consumer to easily and quickly collect debris as seen in FIG. 10. The multiple flat sheets or tarp like bags (15) are placed on the frame (1). This allows the stacking of the flat sheets or tarp like bags (15) and the consumer to rake or place debris and then remove the drawstring/tape to collect the debris as shown in FIG. 12. The system gives an easy non back straining way of waste removal.

Although only a few exemplary embodiments of this invention have been described in details above, those skilled in the art will readily appreciate that many modifications are possible in the exemplary embodiments without materially departing from the novel teachings and advantages of this invention. Accordingly, all such modifications are intended to be included within the scope of this invention as defined in the following claims. While this application uses an example of a debris container, its use is much broader and can be used to contain loose articles outside the waste removal usage.

What is claimed is:

1. A containment article comprising:
a frame coupled to two or more flat sheets by an attachment means and having a peripheral edge portion, wherein the two or more flat sheets are stacked on top of each other.

2. The article of claim 1, wherein the frame is rigid or semi-rigid.

3. The article of claim 2, wherein the frame has a shape selected from the group consisting of square, rectangle, circular, elliptical, and polygonal.

4. The article of claim 2, wherein the frame is made of polymer, metal, wood, or mixtures thereof.

5. The article of claim 1, wherein the edge portion is angled or rounded.

6. The article of claim 2, wherein the frame can be folded upon itself.

7. The article of claim 1, wherein the flat sheets are bags, tarps or a combination thereof.

8. The article of claim 1, wherein the flat sheets are made of a material selected from the group consisting of plastic, paper, polymer, compostable, biodegradable, non-biodegradable, and mixtures thereof.

9. The article of claim 1, wherein the flat sheets each has an enclosure means selected from the group consisting of adhesive, draw string, tape, hook and any combinations thereof.

10. The article of claim 1, wherein the attachment means is selected from the group consisting of strings, ties, loops, posts, holes, cartridges and any combinations thereof.

11. A containment article comprising:
a frame constructed of multiple segments coupled to two or more flat sheets by an attachment means, and having a peripheral edge portion, wherein the two or more flat sheets are stacked on top of each other.

12. The article of claim 11, wherein the segments are connected by hinges.

13. The article of claim 12, wherein at least two of the segments are releasably connected.

14. The article of claim 11, wherein the edge portion is angled or rounded.

15. The article of claim 11, wherein the flat sheets are bags, tarps or any combinations thereof.

16. The article of claim 11, wherein the attachment means is selected from the group consisting of strings, ties, loops, posts, holes, cartridge and any combinations thereof.

17. The article of claim herein the frame can be folded upon itself.

18. The article of claim 11, wherein the frame has a shape selected from the group consisting of square, rectangle, circular, elliptical, and polygonal.

19. A containment article comprising:
a frame having a peripheral edge constructed of multiple segments and coupled to two or more flat sheets by at least three points, wherein the two or more flat sheets are stacked on top of each other.

20. The article of claim 19, wherein the peripheral edge is angled or rounded.
